(19) United States
(12) Patent Application Publication
(10) Pub. No.: US 2016/0303892 A1
(43) Pub. Date: Oct. 20, 2016

(54) Method and Apparatus for Variable Pressure Cutting

(71) Applicant: Provo Craft & Novelty, Inc., South Jordan, UT (US)

(72) Inventors: Richard Harvey Killian, Riverton, UT (US); Jeremy B. Crystal, Springville, UT (US); Robert Woldberg, Centerville, UT (US); Matthew Waibel, Sandy, UT (US); Matthew Lynn Tuttle, Lehi, UT (US)

(73) Assignee: Provo Craft & Novelty, Inc., South Jordan, UT (US)

(21) Appl. No.: 14/689,022

(22) Filed: Apr. 16, 2015

(51) Int. Cl. B44B 3/00; B26D 7/00; B26D 7/26; B44B 3/02

(52) U.S. Cl. CPC B44B 3/009; B44B 3/02; B26D 7/0006; B26D 7/2628

(57) ABSTRACT

An electronic cutting machine includes at least one housing to which a drive roller is coupled for moving a sheet to be cut in a first direction and a cutter assembly coupled to the housing and moveable in a second direction that is perpendicular to the first direction.

### CROSS-REFERENCE TO RELATED APPLICATIONS

This U.S. patent application claims priority under 35 U.S.C. §119(e) to U.S. Provisional Application: 61/980,554, filed on Apr. 16, 2014. The disclosures of this prior application are considered part of the disclosure of this application and are hereby incorporated by reference in their entirety.

### SPECIFICATION

BE IT KNOWN THAT, Richard Killian, a citizen of the United States, Jeremy Crystal, a citizen of the United States, Robert Woldberg, a citizen of the United States, Matthew Waibel, a citizen of the United States and Matthew Tuttle, a citizen of the United States have invented a new and useful apparatus for variable pressure cutting and method of using the same of which the following is a specification:

### BACKGROUND OF THE INVENTION

The present invention relates generally to electronic cutting machines and associated software.

### BRIEF SUMMARY OF THE INVENTION

The invention generally relates to an electronic cutting machine which includes, as main elements, the following items: a cover portion, a roller system, a blade and tool housing portion, and a user input portion. Many such cutting machines are known including those disclosed in PCT/US2014/017524 filed on Feb. 20, 2014, which is hereby incorporated by reference.

There has thus been broadly outlined some of the features of the invention in order that the detailed description thereof may be better understood, and in order that the present contribution to the art may be better appreciated. There are additional features of the invention that will be described hereinafter.

In this respect, before explaining any embodiment of the invention in detail, the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an electronic cutting machine to be used for creating designs with various materials, such as paper, fabric, chipboard, vinyl, cardstock, etc.

Another object is to provide an electronic cutting machine that allows users to cut thick materials through adjusting pressure through a series of cuts.

Another object is to provide an electronic cutting machine that is novel, less expensive, simple, adjustable and more easily accessible to a home-user than the current large industrial machines or applications.

Another object is to provide an electronic cutting machine that allows users to quickly create cuts and projects that are detailed yet precise.

Other objects and advantages of the present invention will become obvious to the reader. It is intended that these objects and advantages be within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

Implementations of the disclosure may include one or more of the following features.

### DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views.

The disclosure will now be described, by way of example, with reference to the accompanying drawings, in which:

FIG. 1 is a perspective view of an exemplary crafting apparatus.

FIG. 2 is an embodiment of the variable pressure logic that may be implemented to adjust the pressure of a working tool over a series of cuts.

FIG. 3 is an alternate embodiment of the variable pressure logic that may be implemented to adjust the pressure of a working tool over a series of cuts.

FIG. 4 is a logic flow diagram of a stepped pressure mode of operation.

FIG. 5 is a logic flow diagram of a dynamic pressure mode of operation.

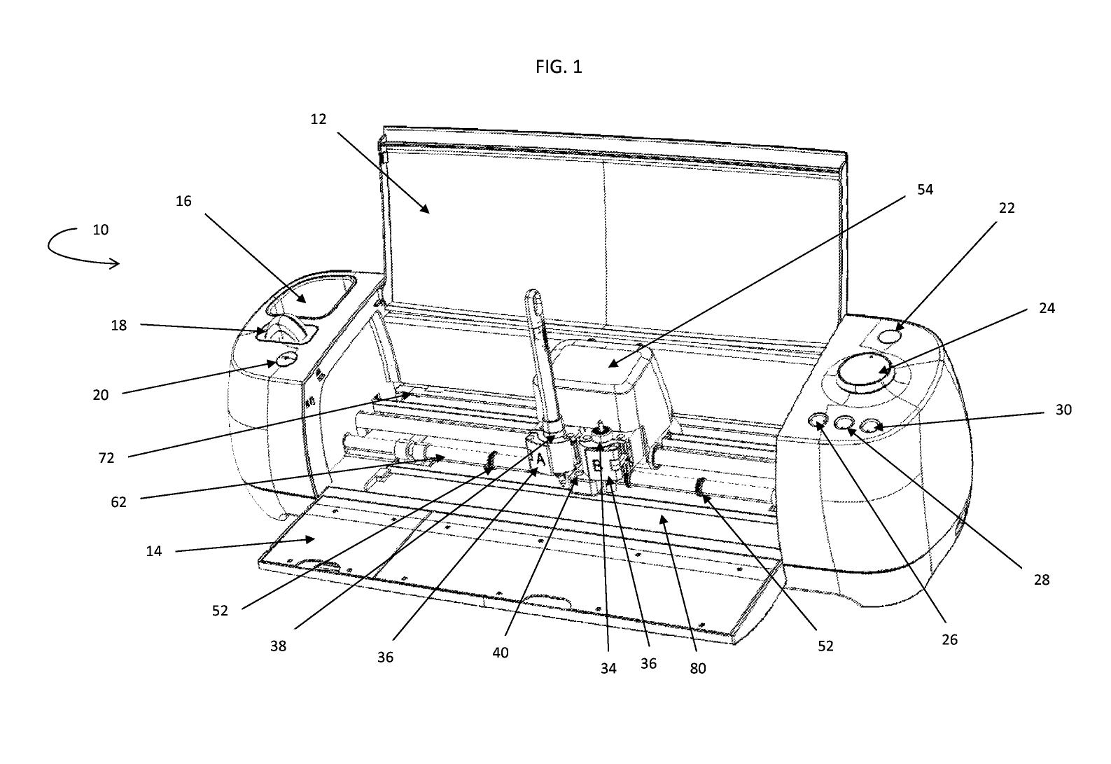

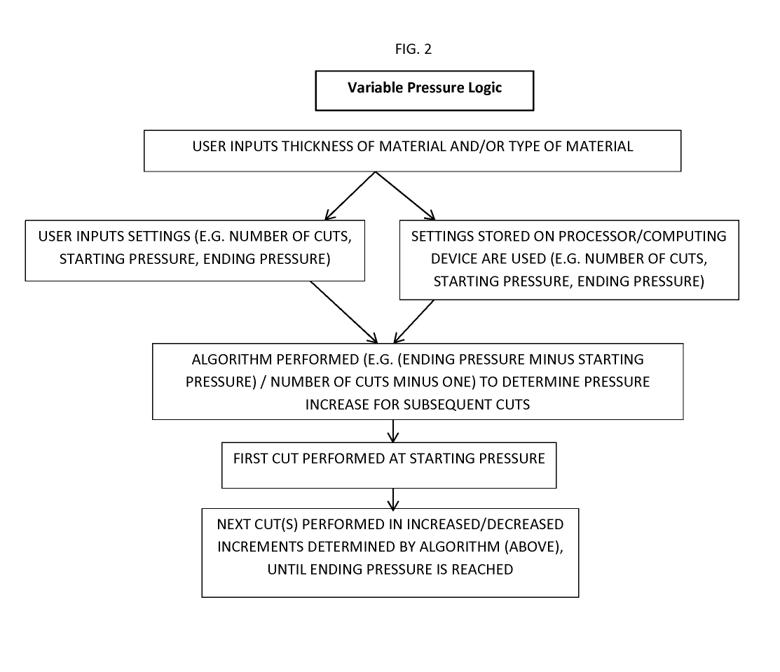

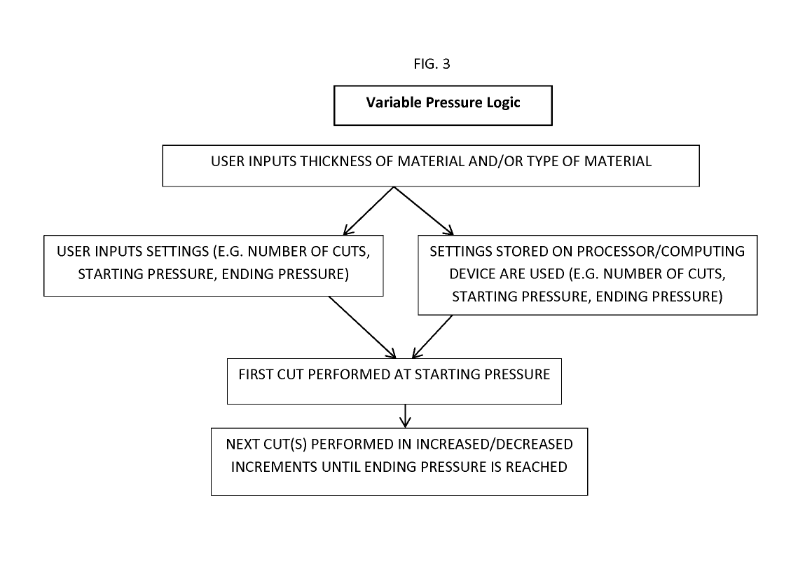

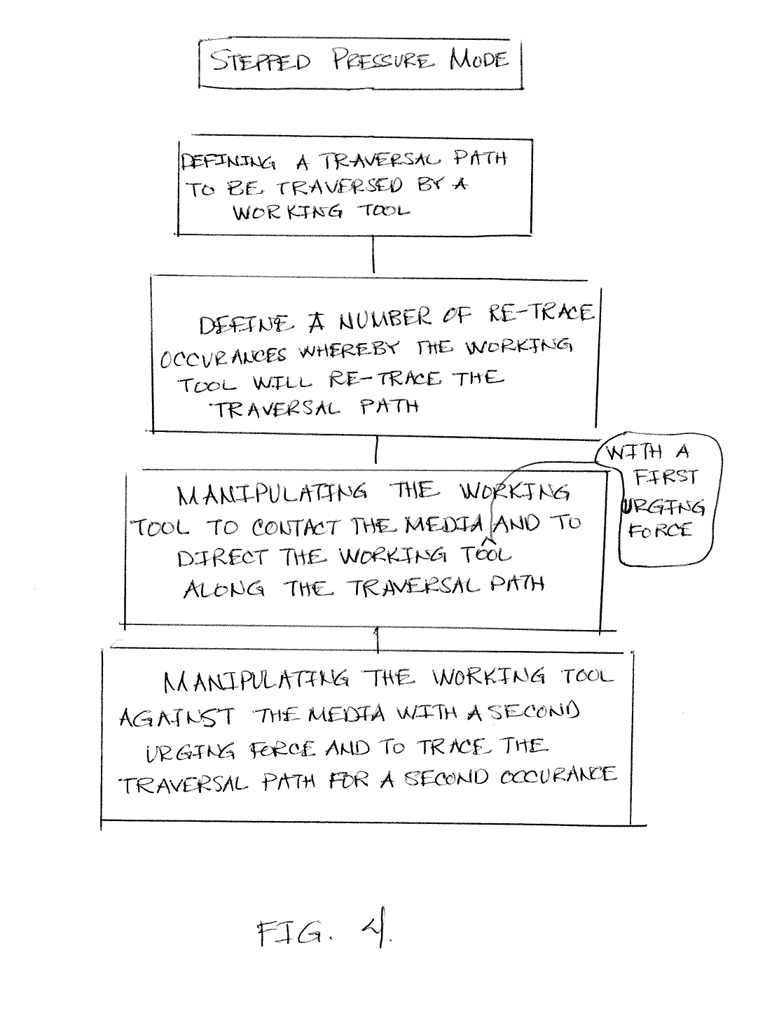

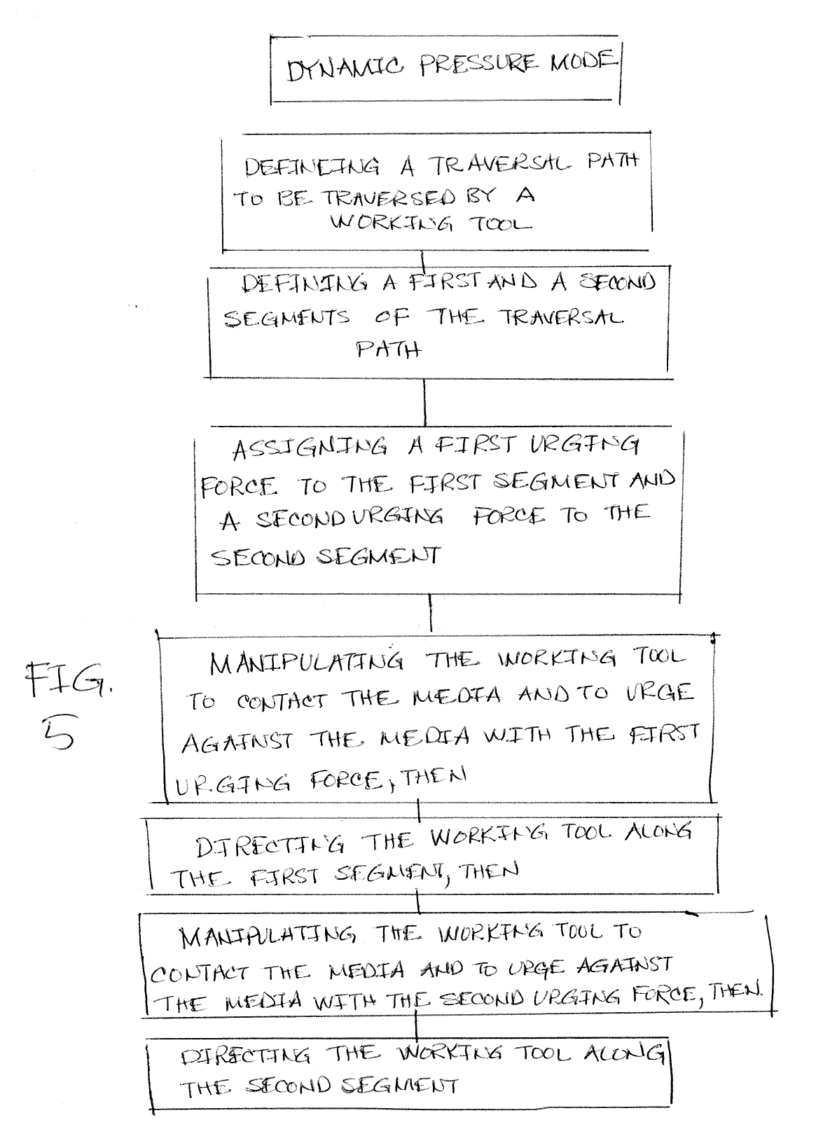

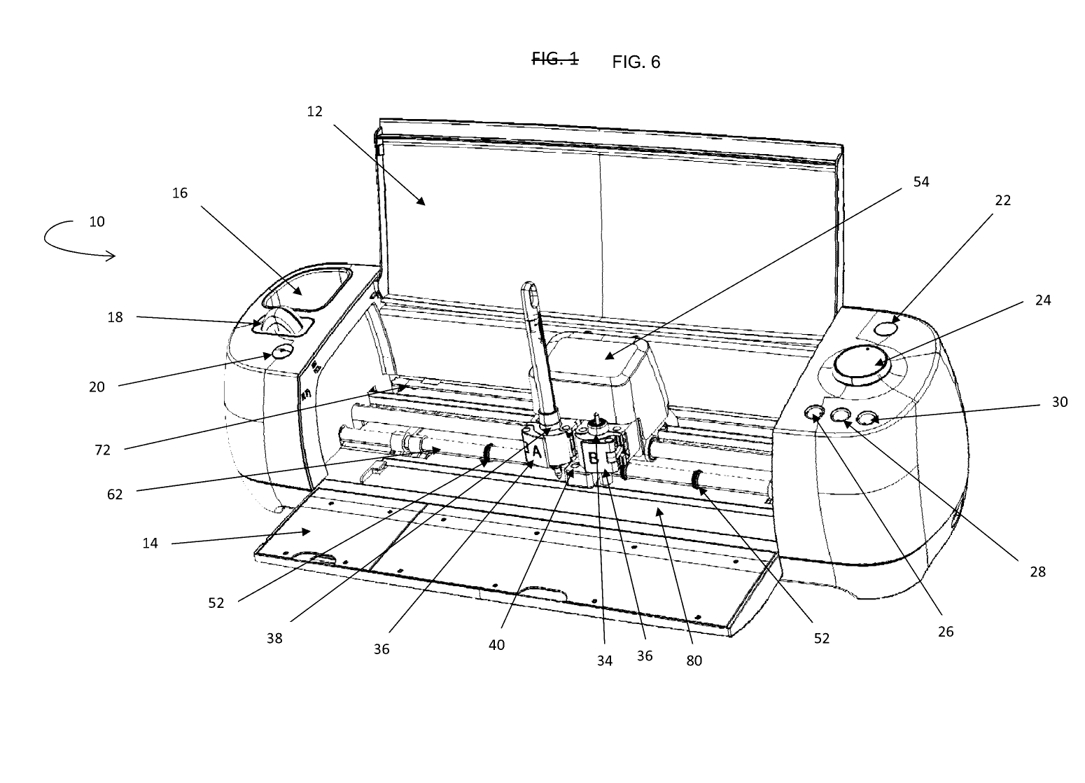

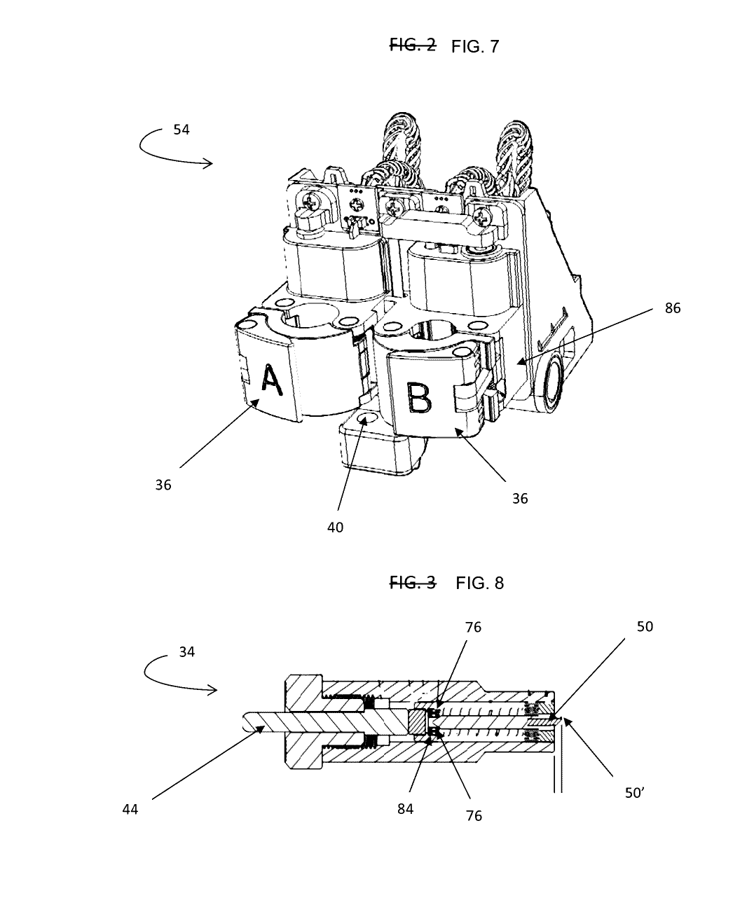

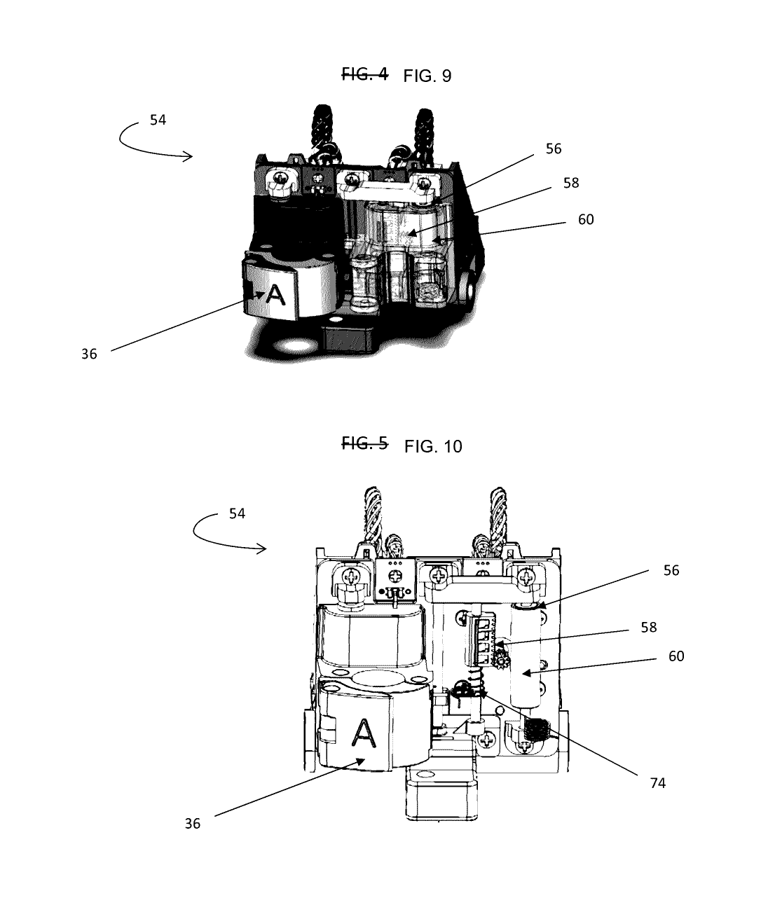

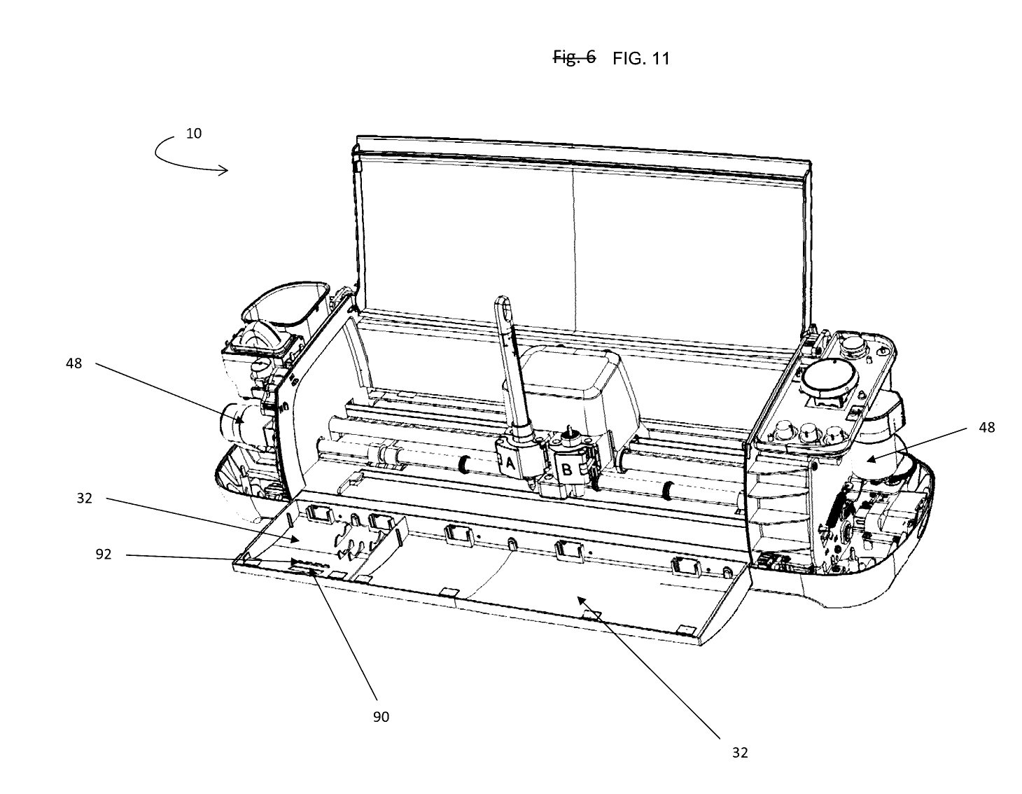

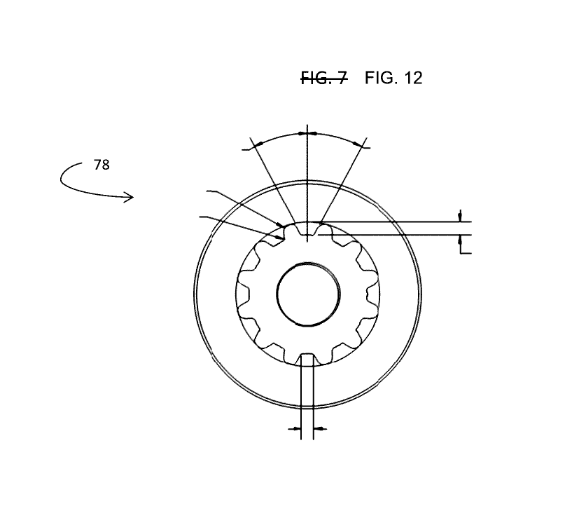

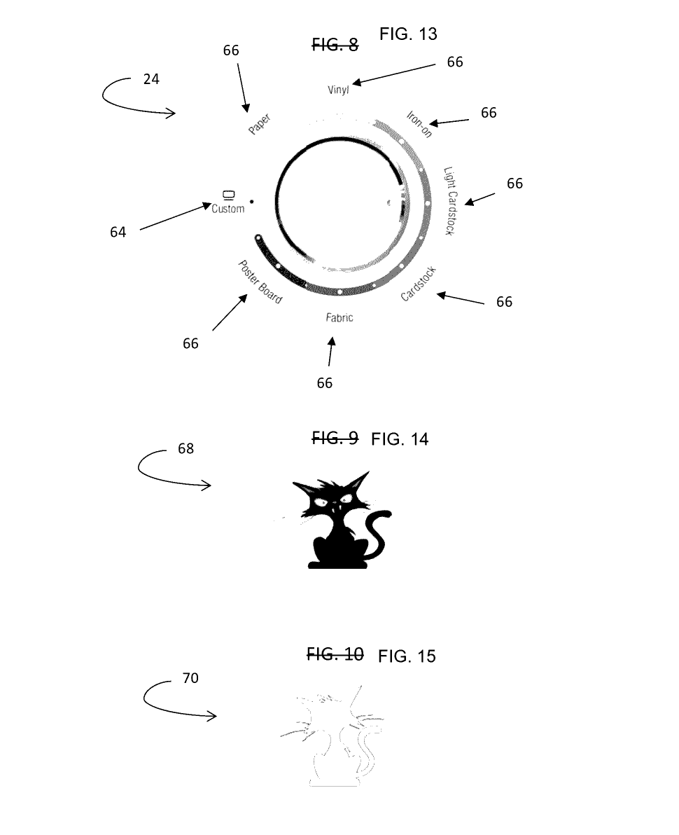

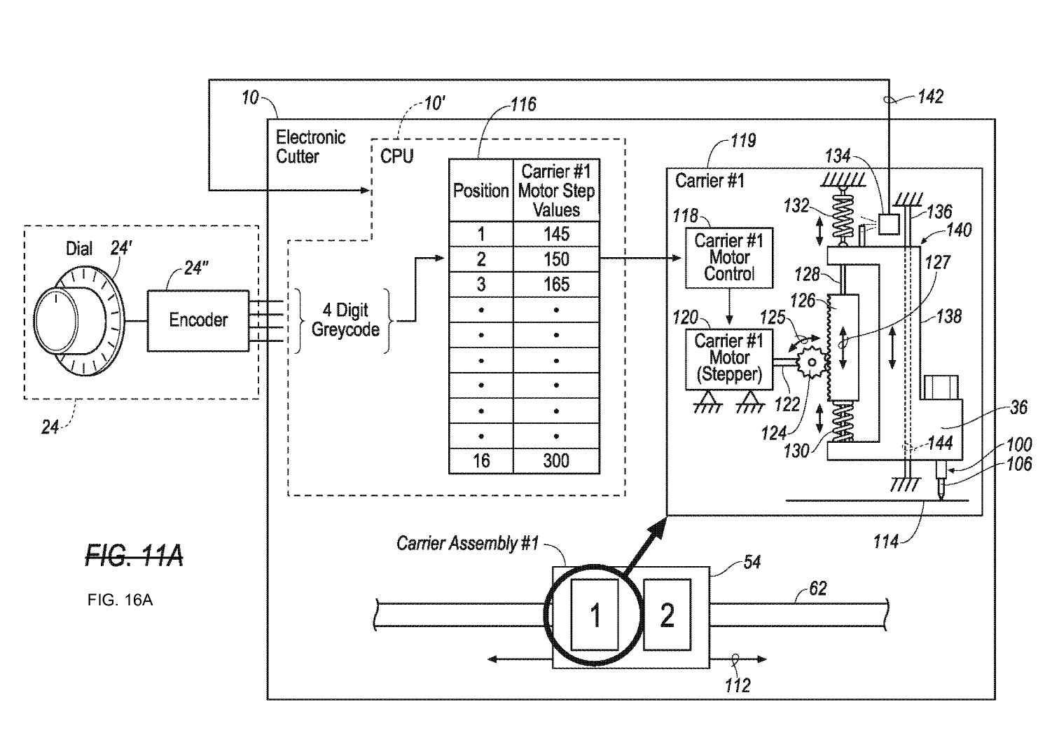

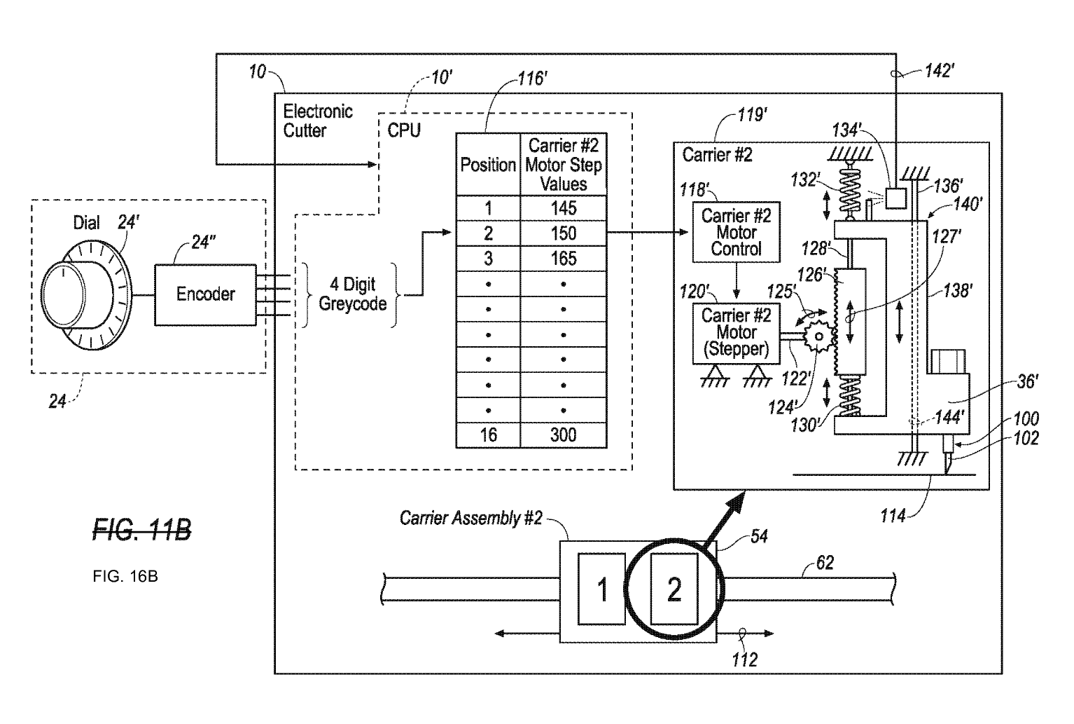

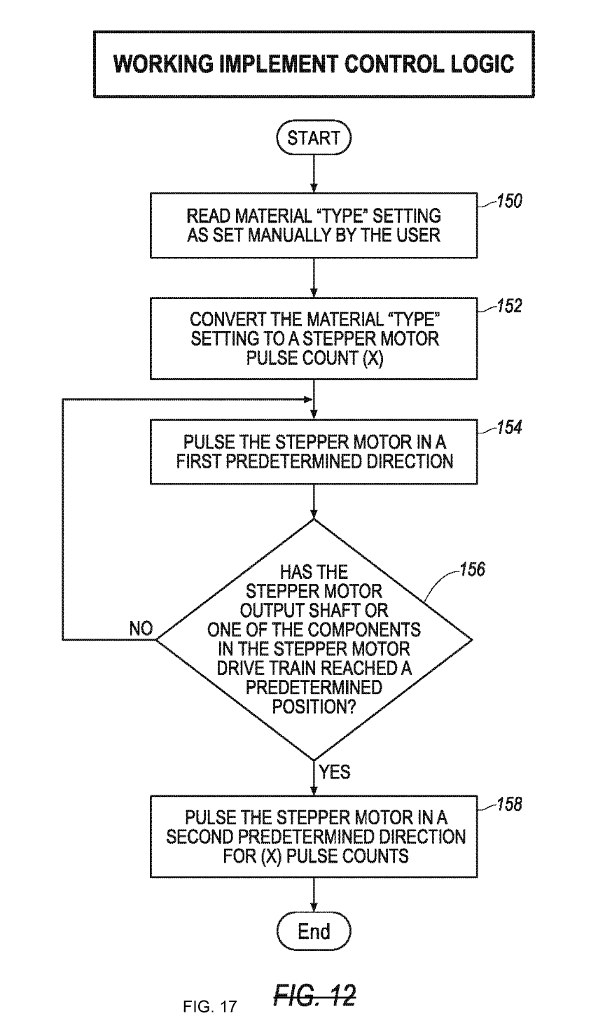

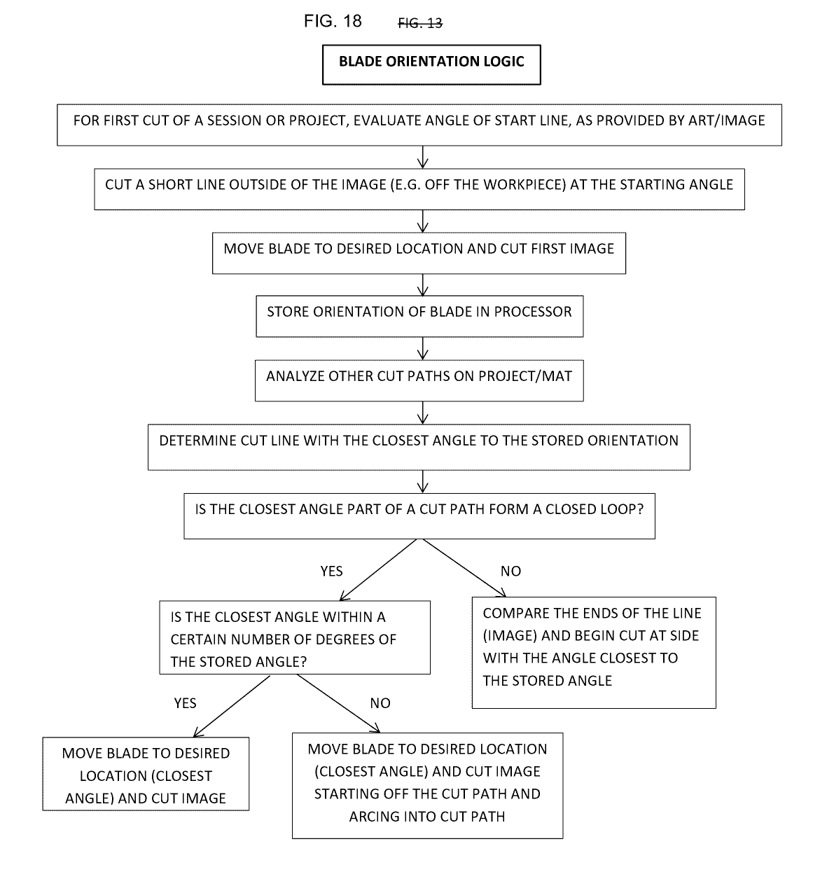

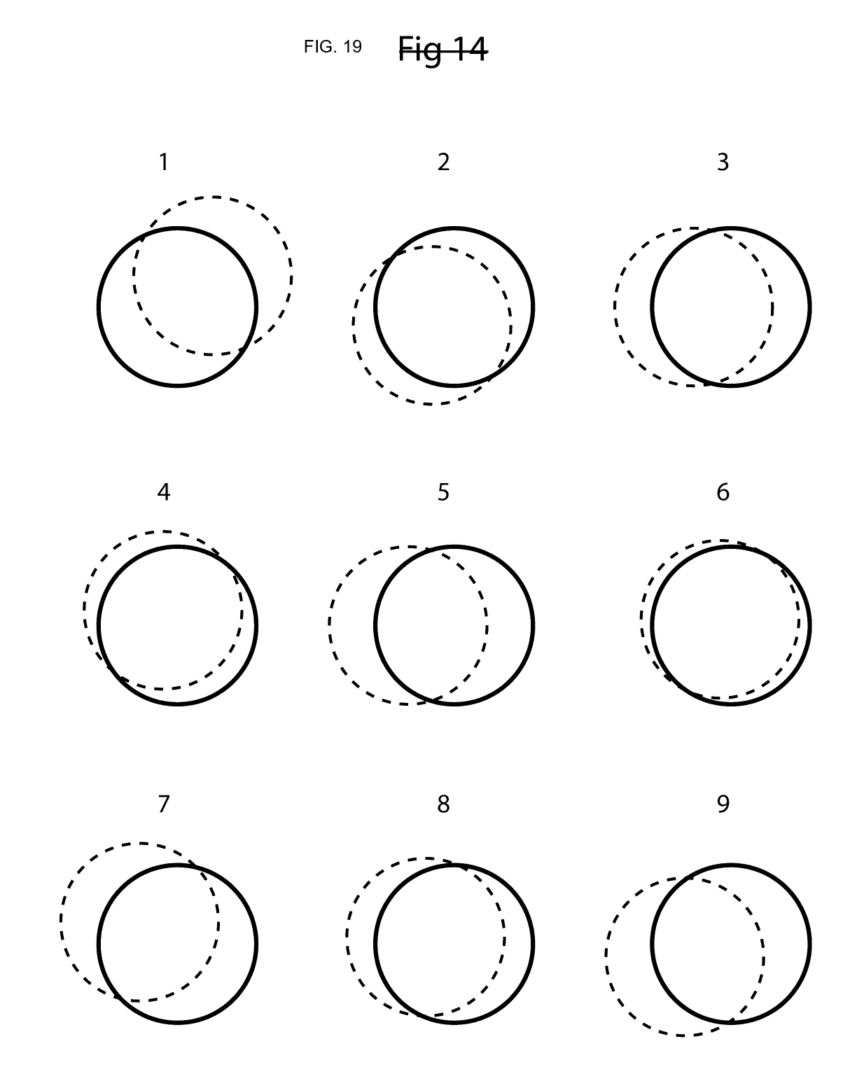

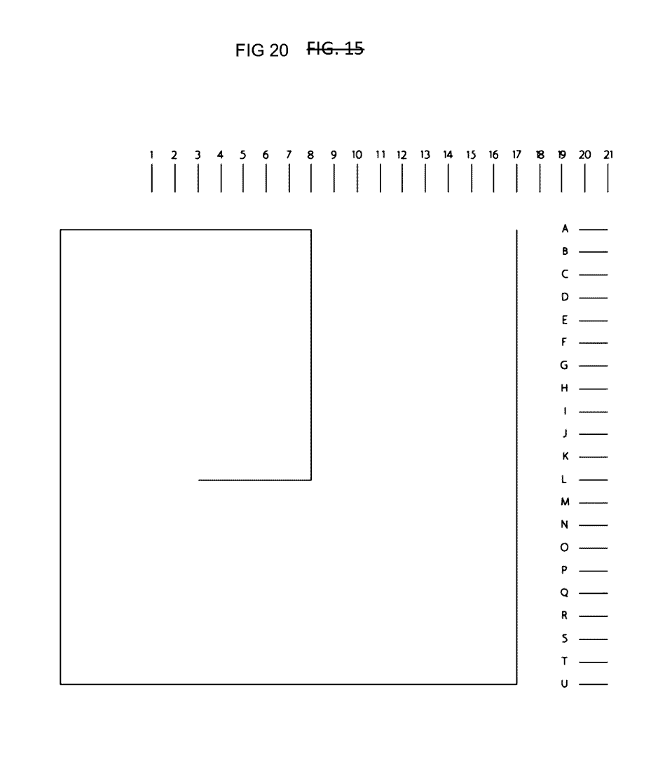

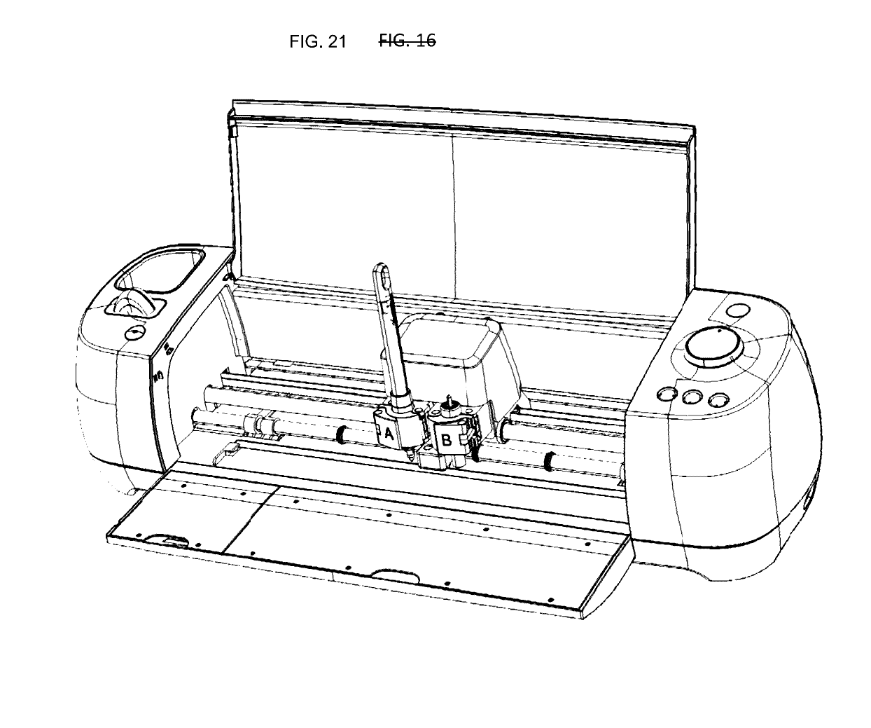

Like reference symbols in the various drawings indicate like elements.

10. Electronic Cutting Machine;

16. Top Storage Compartment;

18. Memory Device Port;

20. Open Button;

22. Power Button;

24. Encoder;

26. Load Button;

28. Cut Button;

30. Pause Button;

32. Door Storage Compartment;

34. Blade Housing;

36. Housing Clamp (on A and B);

38. Alternate Tool Housing;

40. Positional (Z) Sensor;

42. Slot Pin;

44. Solenoid Plunger;

46. Vertical Plate;

48. Servo Motor;

50. Blade;

52. Rollers;

54. Carriage;

64. Custom Setting;

66. Material Setting;

78. Pulley;

80. Machine Floor

### DETAILED DESCRIPTION OF THE INVENTION

### A. Overview

Throughout history, it has been known that individuals have found a sense of personal fulfillment/achievement/satisfaction/expression by creating art. In recent times, during the late 19^{th} century, an art reform & social movement led by skilled tradesmen was slowly starting to be recognized by many people across America, Canada, Great Britain and Australia. This movement has often been referred to as the “Arts-and-Crafts Movement.”

The so-called “Arts-and-Crafts Movement” that began many years ago has continued to evolve today by many persons that may not necessarily be skilled in a particular trade. As such, it may be said that non-skilled persons may be involved in the “arts-and-crafts” as a social activity or hobby. In some circumstances, the activity or hobby may be practiced for any number of reasons ranging from, for example: economic gain, gifting, or simply to pass time while finding a sense of personal fulfillment/achievement/satisfaction/expression.

With advances in modern technology, the “Arts-and-Crafts Movement” that began many years ago is nevertheless susceptible to further advancements that may enhance or improve, for example, the way a skilled or non-skilled person may contribute to the arts-and-crafts. Therefore, a need exists for the development of improved components, devices and the like that advance the art.

Electronic cutting machines have been developed to assist crafters from the fanatical and experienced crafter to the novice crafter in exploring their creativity. These users have a need to cut a wider range of materials, cut more easily and cut more precisely.

### B. Electronic Cutting Machine

Some of the major concerns for existing electronic cutting machines are precision cutting, simplicity, cut settings for various materials, and cutting thick materials. The invention described, addresses these problems.

In an embodiment, the invention may contain an encoder 24, a dial or a material dial, which allows the user to easily select the type of material they wish to cut. In the past, do-it-yourself (DIY) crafters have been required to know and remember the optimal settings to cut out the plethora of materials that can be cut by electronic cutting machines and have been further intimidated by projects that require cutting more than one type of material. Materials vary widely in thickness and texture and switching materials requires adjustments to the speed, pressure, and depth of the blade. Most common materials, include paper, vinyl, iron-on, cardstock, fabric and poster board, all of varying weights and sizes. In the past, changing materials forced users to adjust the blade settings of speed, pressure and depth manually—a tedious and imprecise task.

The present invention may be pre-programmed by the manufacturer or may be programmed by the user to store the optimal ranges for each of the material settings, in for example units of force, pounds, or simply one or more “counts” which represent a magnitude of urging that the tool will exert against the workpiece. The ranges associated with the material settings 66 may be achieved by using techniques such as empirically measuring the amount of force necessary to cut through a given material. Optimal line force settings for the electronic cutting machine 10 or associated software may be for paper 45-65 grams of force; vinyl 50-70 grams; iron-on material 90-110 grams; light card stock 180-205 grams; cardstock 235-265 grams; fabric 260-350 grams; fabric multi-cut materials 250-335 grams; poster board 280-320 grams; poster board multi-cut 275-370 grams.

The present invention contains, or can be user programmed to contain, the optimal speed ranges, pressure ranges and multi-cut numbers for many types of materials to be cut by the electronic cutting machine.

The present invention may contain a multi-cut setting for cutting thicker materials. The user selects a material type and/or the material thickness. The number of cuts and/or amount of pressure needed for various materials is stored by the computer or processor. The numbers of cuts and/or amount of pressure for various thickness of materials will also be stored by the computer or processor. The amount of pressure needed may consist of a starting pressure and an ending pressure.

### C. Stepped Force Mode

Although there are a number of materials which can be cut completely through (i.e., passing the blade completely through the thickness of the media) in a single pass, there are also an array of materials that cannot be cut completely through in a single pass. And, even if a certain material can be completely cut through in a single pass of the cutter, it may result in bunching, tearing, or creating a cut edge which is not clean. With those class of materials that cannot be cleanly cut through in a single pass, the present invention contains a multi-cut mode of operation (a/k/a stepped force mode). For purposes of describing the stepped force mode, a “pass” may mean one or more cuts made by a cutter that collectively results in a completed cut “circuit”. In an embodiment, the user may select one or more of the following: the type of material, material thickness, the number of cuts (a/k/a the number of passes), or the amount of force to be exerted by each cut pass. In an alternative embodiment, one or more of the settings may be pre-programmed and stored into the computer or processor. In an embodiment, the amount of force needed to cut completely through a media may consist of a starting force and an ending force. In some instances, it may be desirable to maintain uniformity or consistency between the force used between two or more cutting passes. Accordingly, it may be desirable, in some embodiments, to increase or decrease the force used per cutting step. This could be implemented in a computer implement algorithm wherein the force to be incremented or decremented per pass is calculated based, in part, on predetermined beginning and ending values along with the predetermined number of passes. For example, the ending force may be subtracted from the starting force and that difference may be divided by the number of desired passes minus one. For example, if it takes four complete passes around the perimeter of an image to be separated from the media to be worked on, and the nature of the material to be cut correlates to a starting pressure of “1” and an ending pressure of “3”, may be set to 3 the following equation is used (3-1)/4-1. The result would be that ⅔'s of a unit of pressure is added each subsequent cut, so cut 1 would be at 1; 2 at 1⅔; 3 at ⅔ and 4 at 3 units of pressure.

In an alternative embodiment, it might be desirable to have a stepped force mode of operation wherein a control algorithm used in the microprocessor can manipulate the cutting blade to an inconspicuous portion of the media to be cut. Thereafter, the algorithm can be used to cut through the media using one or more pieces of user inputted information (from the material dial or elsewhere). Additionally, various heuristics may be used as to the number of passes and the magnitude force increment used per pass. The algorithm can then wait for the user to respond after observing the inconspicuous cut. If the cut is satisfactory (e.g., the cut is completely through the media, and there are no defects in the cut), the user can respond accordingly and the algorithm can continue on with the intended cut. On the other hand, if the test cut is not satisfactory, the user can indicate that the cut quality is not satisfactory and the algorithm can then prompt the user to indicate the nature of the problem (e.g., the cut did not go all the way through the media, the cut was ragged on the entrance surface, the cut was ragged on the exit surface, the blade stalled during the cut, etc.). Once the user indicates to the algorithm what the nature of the problem is, the algorithm can adjust any number of parameters, including cutting speed, the magnitude of force/pressure increments between passes, etc.) and re-initiate the cut.

In an alternative embodiment, in a multi-pass cutting procedure, although it might be sufficient to equally increment the magnitude of each cutting force/pressure across the passes needed to cut through the media, there is nothing that requires the magnitude of the increment between each successive cut to be uniform. For example, in some media that have a hard outer skin and a soft inner core (such as foam board), it may be desirable to make the initial (i.e., plunging) cut-pass using a greater degree of force than the subsequent incremental force used for the remainder of the cut-passes. Likewise, for other types of media, there may be an advantage in starting with a very light cut-pass and finishing with a very strong force/pressure cut-pass.

Although the force/pressure settings used to automate the cut passes can be easily empirically determined and stored in an electronic memory lookup table which may be part of or accessible by the crafting device of the present invention, they may also be generated “on the fly” or as needed using parametric equations or other empirically determined functions.

In an alternative embodiment, it might be advantageous to change cutting blades during one or more portions of the multi-pass cut. For example, in some materials it might be advantageous to make the initial cut with a very shallow cutting blade and thereafter make the subsequent pass cuts with a deep cut blade. In order to implement this mode of operation, the algorithm implemented by a microprocessor stored in the crafting device may prompt the user as to whether or not a cutting blade switch-over is required at one or more stages of the multi-pass cut. The algorithm can then accept the user's input and stop the cutting activity at the appropriate times during the multi-pass cut thereby enabling the user to switch the cutting blades during the stepped force mode cut operation.

Still an alternative embodiment, at one or more pass of a multi-pass cut, it may be desirable to alter the speed of the cut. Accordingly, for a given material, it may be advantageous to cut very slowly during the first pass of the cut and thereafter for subsequent passes, the speed of the cut can be increased.

In an alternate embodiment, the user inputs a thickness measurement for the cutting material and/or a type of cutting material. The user then inputs the settings (e.g. number of cuts, starting pressure, ending pressure) into the electronic cutting machine or into a computing device. An algorithm is then performed to determine the suitable pressure increase (or decrease) for subsequent cuts. One such algorithm is the ending pressure minus the starting pressure divided by the number of cuts minus one. Then the first cut is performed at the starting pressure. After the first cut is completed, the next cut or cuts is performed in increased (or decreased) increments determined by an algorithm (e.g. the preceding exemplary algorithm) until the ending pressure is reached. By the time multiple cuts have been made and the ending pressure is reached the desired image should be completely cut out of the cutting material.

Although the term “cut” includes cutting along the entire perimeter of an image to be separated from the media, there is nothing precluding the present invention from varying; during a given cut pass, the cutting force from sub-segment to sub-segment of the entire image perimeter.

### D. Dynamic Pressure Mode

It may be desirable when using certain tools (calligraphy pens, scribes, and the like), to vary the force/pressure during a stroke (i.e. traversal path) of the tool. For example, when using the invention to create calligraphy, increasing the force/pressure during various portions of a given character stroke may allow superior control over the width and darkness of a given stroke line. Likewise, when using a scribe tool to emboss a media, increasing or decreasing the force/pressure on the scribe tool will allow control of the depth/shallowness of the scribed line.

In a given embodiment, a given character (e.g., letter, numeral, glyph) is assigned one or more sets of xyz coordinates which define the segments required to render that character (or portions thereof) where the “Z” coordinate controls the downward force asserted by the tool against the media which is being worked on.

In an embodiment, the setting of one or more “Z” coordinates across one or more segments required to make a character (or portions thereof) can be defined by the user so that the user can customize their own calligraphy font style.

In addition to calligraphy and scribing applications, there may be other applications where adjusting the “Z” force on the fly (i.e., during or between strokes) is useful. For example, in some cutting applications, it may not be desirous to simply puncture the media and start cutting. In those cases, it may be desirous to slowly lower the cutting blade along the “Z” axis of the blade until the cut is initialized to start the cut. This approach allows preservation of the blade life and it may assist in actual blade alignment in eliminating gouges in the media caused by the spinning of a castering style blade as it attempts to orient itself parallel to the desired cut direction. Using this dynamic pressure approach as it applies to cutting, works exceptionally well because the typical blades used in these cutting applications are castering style which are designed to caster when they are dragged along the media to be cut. In order to orient the cutting blade so that it has the correct cutting angle (i.e., parallel to the desired cut line) the blade must be lowered very slightly until it just tickles the surface of the media to be cut. Thereafter, the blade will orient itself due to the friction it experiences as it is drawn across the surface of the cut media, and thereafter the blade can be plunged into the media to be cut and the cutting may be commenced in earnest. This approach to gradually lowering the working tool is also applicable for felt pens and calligraphy pens in order to avoid slamming the pens onto the media and depositing too much ink (thereby causing blotching, etc.).

Still in another embodiment, using the dynamic pressure approach to remove a felt tip pen (or other marking implement) from the media to be marked, will also prevent blotching (i.e., depositing too much ink) at the time the pen is lifted from the media. If the pen is gradually lowered from the media during the initiation of a segment or if the pen is gradually lifted to terminate a segment, there is less tendency for the ink to bleed from the pen and to over-saturate the media. By “flying in” (i.e., gradually lowering the tool along the “Z” axis as the tool is being moved along at least one of its “X”, or “Y” axis) to start the marking and by “flying out” (i.e., gradually lifting the tool along the “Z” axis away from the media as the tool is being moved along at least one of the “X” or “Y” axis) to end the marking, significant advantages are obtained in eliminating pen bleed on the media to be marked.

Still another embodiment, dynamic pressure mode of operation can be used in embossing. Specifically, embossing is commonly used on various stock using a scoring tip tool to emboss on metal foils, corrugated board, or any media which will change in appearance once a scoring tool is dragged across it. Depending on the amount of pressure that is exerted on the scoring tool, different effects can be observed on the surface of the media. Specifically, using varying force/pressures on the scoring tool, various terracing effects (i.e., 3-D type effects) can be accomplished. Entire 3-D images can be built upon various media such as foils, leathers, and the like by varying the force in which the scoring tip is exerted against the media.

In one embodiment of the invention pressure placed on the tool (e.g. drawing pen or cutting blade) or the tool housing holding the tool is automatically (dynamically) controlled while the tool is moving.

In one embodiment a drawing pen is used instead of a cutting blade in order to draw with calligraphy. The drawing pen is held in a vertical position in and the line thickness of the line drawn is determined by the amount of force placed on the drawing pen or the tool housing holding the drawing pen. This system would require 3d coordinates which differ from the 2d systems utilized by current electronic cutters and plotters. In the 2d crafting device systems, content contains x and y coordinates and the z-axis is static. The artwork or content to be drawn utilizing the instant invention would be designated by a series of x and y coordinates (as with the current 2d systems), but would also contain corresponding z-coordinates.

In one embodiment the lines to be drawn would be broken up into shorter and shorter line segments (i.e. traversal paths) in order to vary the z-axis more often and over shorter paths.

In an alternate embodiment, the user may manually select the starting pressure and/or ending pressure and/or number of cuts.

In an alternate embodiment, the computing device or processor store appropriate settings (e.g. number of cuts and pressure applied) for various materials and the user simply selects their material, rendering a separate calculation or algorithm step unnecessary.

In an alternate embodiment, the user manually increases or decreases the pressure on each of the successive cuts of a specific image in order to more precisely cut completely through the cutting material.

In an alternate embodiment, the settings associated with each material, could instead or in conjunction be determined by the user or by the electronic cutting machine 10 depending on the intricacy of the pieces to be cut.

In an alternate embodiment the 24 encoder is an incremental dial with set positions.

In an alternate embodiment the 24 encoder is a material dial.

In an alternate embodiment the material dial is a sixteen (16) position encoder.

In an alternate embodiment the 24 encoder would contain an analog dial that does not have set positions for specific materials.

In an alternate embodiment the 24 encoder is a potentiometer dial with digital or analog set points.

The new encoder (or material dial) eliminates the manual blade adjustments and alleviates the hassles of remembering optimal material settings and of cutting different materials in general. The user turns the 24 encoder to the appropriate 66 material setting and presses the 28 cut button and the 10 electronic cutting machine applies the optimal blade settings for that material.

If the user wishes to cut a material that is not preprogrammed on the machine or associated software, an embodiment of the electronic cutting device has a 64 ‘Custom’ setting for the user to choose from a preset materials list on the 10 electronic cutting machine or associated software or both, and save settings based on their personal preferences.

In an alternate embodiment, the operator of the machine may modify the preprogrammed settings for a given material through the machine or associated software.

At the factory level, each machine is calibrated by measuring force at the blade contact point required to cut a specific material and then the required force is compared that to the number of motor steps to reach that force. The number of motor steps, force, or both are stored by the machine in a manner that corresponds with the specific material. If the force is not appropriate, then user may increase or decrease the motor steps, force or both in the material settings on the machine or through the associated software.

In an alternate embodiment, to calibrate each material setting half-steps are measured to reach the required force to cut a given material. This method reduces the variation that is due to springs and tolerance.

The present invention eliminates blade depth adjustment by the user.

The present invention implements motor driven blade engagement and pressure control including vertical actuation for controlling depth and pressure of blade for more precise cutting.

The present invention utilizes z-actuation with a 48 servo motor.

An alternate embodiment of the personal electronic cutter implements a 56 linear bearing to provide a very low friction environment.

An alternate embodiment the 56 linear bearings are in a 60 tube (e.g. steel tube) to provide for better alignment. The 60 tube may then be bolted into a plastic part.

An alternate embodiment contains a split bushing in place of the 60 steel tube with the 56 linear bearing(s). The split bushing performs the same function as a sleeve, but allows the bearings to be placed without press fit force (or excessive force to press fit). The tube may then be placed inside the machine plastics securely despite variances in the plastics.

The invention described incorporates a software algorithm that remembers the 50 blade orientation from the previous cut so that the 50 blade can be pre-aligned prior to beginning the desired cut. The direction of the 50 blade is stored by the 10 electronic cutting machine or associated software so that it may be moved into the optimal position before or as it is being lowered into cutting position. The tool (e.g. 10 blade) is pre-aligned and then remember where the orientation and then start the next cut or print in an orientation that is closest to the current alignment. This pre-alignment ensures the cleanest start of cut and end to cut and that there will not be any, or as much, undesired material left on the resulting cut material. Once aligned, the appropriate force may be applied to the 34 blade housing ensuring that that when the 50 blade first comes into contact with the material to be cut the 50 blade is aligned correctly to follow the desired cut path.

In an alternative embodiment, at the beginning of the desired cut, a low force is applied to the 34 blade housing. As the cut continues the force placed on the 34 blade housing is increased so that the force required to cut through the material is not applied until it is more certain that the 50 blade is aligned correctly to follow the desired cut path.

In alternative embodiments the force applied to the 34 blade housing is gradually changed (increased/decreased) or is immediately set to the optimal amount of force once the 50 blade is properly aligned.

The preferred embodiment of the invention contains soft pressure orientation where the 34 blade housing or 38 alternate tool housing descend with low pressure to allow the 50 blade to swivel into position before increased pressure is applied and cutting begins. The actuation for this soft pressure orientation may be performed by a stepper motor or a servo motor in the z-axis.

Cutting machines are required to precisely cut a wide variety of different shapes, sizes and materials. At the core of the new architecture is an intelligent hybrid motor system that dramatically improves blade control and cutting precision.

While most current commercial electronic cutting machines use stepper motors, the preferred embodiment of the instant electronic cutting machine uses a 48 servo motor. The 48 servo motor allows the electronic cutting machine to operate more quietly and allows more control and precision of the cutting. The 48 servo motor allows feedback control to better enable the machine to recognize the tool's (e.g. 50 blade's) exact location. Other advantages of the 48 servo motor include, they are less expensive, operate more quietly, and are more efficient (use less power).

Each 10 electronic cutting machine may be calibrated on the manufacturing line to ensure the materials settings are precise, the draw and cut lines are aligned, and the cuts are accurate. Once the 10 electronic cutting machines are produced, random samples are pulled for extensive materials and cut testing.

Even with the greatest attention to detail, there are variances in each machine rolling off the production line. To further enhance the preciseness of cutting, printing, drawing, scoring, etc., the 10 electronic cutting machine incorporates a software algorithm that will allow the factory personnel or the end user to calibrate the machine to ensure alignment between the 34 blade housing and the 38 alternate tool housing. Not only will this algorithm allow the factory to calibrate the 10 electronic cutting machine prior to being shipped, it will also allow users to recalibrate the 10 electronic cutting machine if they notice variances or inaccuracies in the cutting, drawing, embossing, or scoring of the 10 electronic cutting machine.

The first step of the preferred method of calibrating the 34 blade housing and the 38 alternate tool housing is by performing the operation designed by one of the housings, more than one time on a material, in variable offsets. After the first step is completed the material would be placed so that the 10 electronic cutting machine could perform the operation of the other housing more than one time on the material, in variable offsets. The resulting marks are indexed and marked with an identifier, such as a number, letter or other symbol. The operator then reviews the at least four results or marks on the material and selects which of the pairs of marks align exactly or most closely.

The preferred embodiment of the invention contains a 40 position (z) sensor that may be aligned with a 50 blade or 34 blade housing or 38 alternate tool housing. The sensor checks alignment with the 50 blade by referring to at least two corresponding fiducial marks.

The method described includes determining a number of steps to move the 50 blade or 54 carriage a first distance in a first direction, determining a number of steps to move the 50 blade or 54 carriage a second distance in a second direction orthogonal to the first direction, creating (drawing, scoring, etc.) calibration images with the alternate tool, and cutting the calibration images with the 50 blade. Each calibration image is cut with a cutter offset different from the other calibration images. The method includes selecting a cut calibration image and using the cutter offset of the selected calibration image for cutting operations. In some implementations, the method includes locating first and second marks spaced from each other along the first direction on a mat received by the 10 electronic cutting machine and then determining a number of steps to move the cutter along the first direction between the first and second marks. The method may also include locating third and fourth marks spaced from each other along the second direction on the mat and then determining a number of steps to move the cutter along the second direction between the third and fourth marks. In some examples, calibration images comprise at least one of horizontal lines and vertical lines.

In an alternative embodiment of the invention, there are only two marks made, one by one housing and one by the other housing. With this alternative embodiment, the operator chooses whether the marks are aligned or not.

In a preferred embodiment, the 10 electronic cutting machine may perform actions that allow the operator to determine how much backlash the machine has. In one embodiment, the 10 electronic cutting machine will operate so the blade cuts through a stair like sequence of vertical and horizontal cut paths going in one direction across the cut media (first series of cuts), then bring the 50 blade across the cut media in the opposite direction (second series of cuts) so that they minor the first series of cuts. The user then measures the middle of the line to ensure highest degree of accuracy and to account for the 50 blade to swivel into place.

In a preferred method the second series of cuts is far enough from the first series of cuts to ensure the 50 blade does not slide into a trough created by the first cut. To help ensure that the 50 blade does not fall into a trough and to make it easier for a user to determine the amount of backlash, the backlash is multiplied by a factor, for example by 10× or 100×.

In alternative embodiments, on the manufacturing line, or at the end user level, the operator of the 10 electronic cutting machine may cut a matrix or array of small circles (e.g. 5 mm) with different levels of backlash applied in a graded fashion for each column and row corresponding to X- and Y-axis backlash. For instance in one direction (e.g. across the material) the X-axis varies and in the other direction (e.g. down) the y-axis varies. By the operator inspecting and selecting the best circle either manually or with an automated optical measurement machine then determines the appropriate backlash to be applied by the machine, firmware or associated software to ensure the best cut accuracy. Each machine may be calibrated on the production line to reduce or eliminate sources of machine to machine variation.

In an alternate embodiment, the machine may cut out one or more circles and then allow the user to manipulate the circle(s) with the machine or software in order to instruct the machine how to correct for any backlash.

In an alternate embodiment, the x- and y-coordinates would vary one at a time. For instance the user would test all of the x-axis variants and select the best one and then test all of the y-axis variants and select the best one.

In an alternate embodiment print paths from an ink cartridge, writing utensil, pen or an embossing path is created and tested.

In alternative embodiments, this “backlash algorithm” can be performed at a factory/manufacturing level or at the end-user level.

The preferred embodiment of the current invention contains a new 78 pulley with a gentle radius at the top of the 78 pulley tooth to push the belt further in advance so that it more likely to be in the correct spot when the next tooth comes into contact with the belt and it provides an easier run in for the cog of the belt. The larger radius on the belt lead in to avoid “catching” the belt tooth on the pulley tooth. This invention allows the electronic cutting machine to run with a smaller pulley diameter than recommended. If further reduces wear and tear on belt and the vibration in the system.

A brand-new 34 blade housing takes advantage of the new 50 blade tip with a sophisticated springloaded, dual 76 ball bearing design that allows the 50 blade to spin freely, enabling the most intricate of cuts.

The upper standard 76 ball bearing assembly is used to capture the cone of the end of the 50 blade instead of having loose ball bearings ride on the end of the 34 blade housing. This invention allows for smoother spinning of the 50 blade and is less susceptible to debris interfering in the spinning of the 50 blade, as is the case with current electronic cutters.

The carriage or apparatus containing or holding the 34 blade housing is spring loaded to allow the 50 blade to ride along paper with imperfections. Preexisting machines use brass or bronze bushings and when a side load is added the 50 blade does not float easy enough for precise cutting on uneven surfaces. The present invention includes a 58 rack gear which floats up and down. Further the 56 linear bearings are made to go in a single linear direction.

The current invention contains a slider assembly with a 74 non-linear spring or two springs used in series (an upper and a lower spring). The lower spring still acts as a spacer. The upper spring, preferably a very soft spring, allows the machine to have a wider half step range on materials. This invention is especially important on materials with a narrow range of displacement, for example vinyl. The half steps allow for a wider range of displacement for the same force range which helps the machine cut thin materials such as basic printer paper (e.g. 20-30 lb).

An alternative embodiment of the invention, one or both of the springs is a variable rate spring. This allows for lower force on the low end and then stiffness of the spring increases as it is deflected more.

The 76 ball bearings are used unconventionally to allow the 50 blade to seat on the inner race of the 76 ball bearing which in turn allows the 50 blade to spin more freely within the 34 blade housing, leading to less friction and more precise cutting.

In the present invention there is just a conical contact between the 50 blade and 76 ball bearing which allows the 50 blade to turn freely and also helps avoid the problem of many electronic cutters where paper or dust gets caught in the blade housing and lessens cut preciseness.

In an alternate embodiment, the upper bearing is 1.5 mm ID and the lower bearing is 2 mm ID.

The cut assembly adds precision with a unique dual-axis configuration combining the best features of both stepper and servo motors. A motor (high-torque stepper motor) drives a gear (58 rack and pinion gear) that compresses a spring, allowing highly granular control over the blade assembly, for instance, adjusting the pressure as needed based on the user selected material setting. 56 Linear bearings housed in the 60 tube (e.g. metal tube) ensure precise alignment of the 56 linear bearings and dramatically reduce friction, creating a smooth and consistent cut depth. The result is an unprecedented level of control over 50 blade depth and pressure across the entire cutting path. When a cut starts, the assembly reads the cut path and then adjusts the speed to accurately cut the close corners—real-time adjustments that limit deviance from the cutting path.

An alternate embodiment of the invention contains software/firmware that automatically adjusts cutting speed so every cut is smooth from start to end. This is especially crucial as the 50 blade travels around tight corners or in and out of tight angles.

The preferred embodiment of the invention contains cam actuated 36 housing clamps making the clamps easier to open to access the 34 blade housing or 38 alternate tool housing. This invention also allows the user to simply drop in the 50 blade or alternate tool and still ensure the height of the 50 blade or tool is correct.

In an alternate embodiment the cam actuated 36 blade housing clamp(s) is spring loaded so that the clamp opens more fully when the cam is open.

In an alternate embodiment, the 34 blade housing (or holder), or 38 alternate tool housing (or holder) or both contains or a collet style accessory clamp or finger like features to ensure that when the blade or tool are dropped in, they are at the right insertion depth and that the 50 blade or alternate tool is secure during operation.

In an alternate embodiment the 34 blade housing, or 38 alternate tool housing or both contain a bladder like device that may be expanded or contracted to further secure the 50 blade or tool into the housing to ensure for more precision in performance (e.g. cutting, printing, drawing, scoring, etc.).

To ensure that the 80 machine floor is flat, the floor is measured at factory level. In existing machines the 80 machine floor is held with screws. In the current invention the 80 machine floor is held down with speed nuts.

In an alternate embodiment the 80 machine floor flatness is measured with a load cell. The flatness is dynamically measured so that the 50 blade or tool is raised or dropped the appropriate across a given path (e.g. cut path), so that as the 50 blade or tool moves across the path it is moved up or down based on variations in the floor. This helps ensure an optimal amount of pressure is applied all the way across the mat.

In an alternate embodiment the 80 machine floor flatness may be measured with an optical measurement system or a touch probe. With digital feedback built right into the machine, the calibrated 80 machine floor flatness may be used to determine how to adjust the 50 blade depth or pressure on the fly.

In an alternate embodiment the 80 machine floor flatness is enhanced by a placing a silicon washer under the push nut or speed nut to ensure that when the 80 machine floor is manufactured the 80 machine floor is flush and when the 80 machine floor is pushed into place the nut gives you enough over travel with the material (e.g. silicone) the nut expands and then washer takes up the over travel rather than having the floor spring back or lift a little. Without the washer you would get push in the floor and may have dimples where screw is placed into.

An alternate embodiment of the 10 electronic cutting machine contains a screw backstop for belt tension. A screw is added to the belt tension bracket to ensure the spring from compressing for ease of installation and maintaining belt tension. The problem being addressed is that in existing machines, when the spring gets compressed the belt becomes loose. In the present invention the spring is braced so that it cannot compress as much, or at all, and the screw acts as a stop.

An alternate embodiment of the invention contains an 72 anti-rotation member to keep the 54 carriage for the 50 blade and/or tool housings from tilting back and forth. Invention contains a plastic rail that presses against the bottom of the 72 anti-rotation rail with an opposing spring loaded button which presses on the top rail such that the 54 carriage is held between the top and bottom rail. This works to eliminate all front to back rotational slop in the carriage system.

An alternate embodiment of the invention contains a 52 roller, rubber cone or ring to be placed on the 62 shaft that would be flexible yet still hold down the material to be cut and maintain constant pressure on the cutting material.

In an alternate embodiment the 52 roller, rubber cone or ring would be made of stiff rubber (e.g. 70-80 durometer).

In an alternate embodiment multiple (e.g. 3-4) 52 rollers, rubber cones or rings would be placed on each roller or shaft.

In an alternate embodiment of the invention, multi-layered fonts are created and utilized. So that each font consists of multiple layers that when placed together (on top of each other) give dimension to the font, image or other artwork.

Exploiting the feedback capabilities of the 48 servo motors, the device firmware adjusts 50 blade speed to ensure the most precise cut possible. The new software ensures more perfect cuts by anticipating changes in the cutting path and controlling the speed around sharp corners—thereby eliminating tears and jagged edges. The firmware also keeps track of 50 blade orientation as the assembly moves from one image to another on a sheet of material. The tip of the 50 blade is cast in a finely-grained metal which better resists wear and breakage, greatly extending the expected lifespan of the 50 blade.

In an alternate embodiment of the invention the 50 blade tip is cast in specially formulated tungsten carbide.

The present invention included a change in the 50 blade geometry that improves accuracy and optimizes cuts across a wider range of materials. The new geometry extends the life span of the 50 blade tip even further, providing users with a noticeable increase in cutting distance. The new 50 blade design also makes it easier for the 50 blade to navigate sharp corners, adding more precision and speed.

An alternate embodiment of the invention contains a torsion tie rod on either or both of the doors (12 top door or 14 bottom door) to ensure that the door remains in proper alignment to improve alignment of the plastics and aesthetics when the door is closed (so the door is flush with surrounding machine pieces) and to improve overall rigidity.

With the design software users may upload files containing images to the Cut What You Want® tool to convert their own design into a cuttable image in a few clicks. There are other programs available that convert normal image files (e.g. .jpg, .png, .svg) into “cut-path” instructions for an electronic cutting machine. The novelty of the present invention is the ease at which the users may accomplish this. Other software requires the user to jump through many hoops before achieving the results.

Users of the present invention will only be required to complete three easy steps before being able to accurately and precisely cutting their uploaded image.

The present invention also allows users to purchase subscriptions to the content library (e.g. month-by-month or annual) to receive unlimited access to the thousands of images contained in the content library.

Further, users are allowed to try the images by placing it on the worksheet, available in the software, before electing to purchase the images. This allows the users to play around with the images before making the purchase. Users are only required to purchase the images the elect to cut with the electronic cutting device.

An alternative embodiment of the 10 electronic cutting machine and associated software allows users to perform actions (cut, print, draw, score) on both sides of the paper.

An alternate embodiment of the 10 electronic cutting machine determines the location to perform the desired action by cutting a design (e.g. a slit, square, or diamond) before, while, or after performing the desired action on side one of the cutting material and then finding the design after the cutting material has been flipped to the opposite side.

An alternate embodiment of the 10 electronic cutting machine contains a cutting mat with the marks to represent the most common sizes of paper, cards or other material or projects to be created (e.g. 3″×5″, 4″×6″, 8.5″×11″). The user would place the cutting material within the borders or marks and then perform the desired action(s) (e.g. cut, print, draw, and/or score) on the first side of the cutting material and then flip the cutting material to the opposite side and place it again within the same borders or marks and then perform the desired action(s) on the second side of the cutting material.

The terms “force” and “pressure” have been used herein to describe the control commands that are sent to the “Z” axis control mechanism of the crafting device which is effective for moving a tool (cutter, scribe, pen, etc.) along a “Z” axis (the “Z” axis is the axis which at least has a vector component of its constituent make-up that lies normal to the plane of the media). Of course, while it is possible that actual downward force/pressure of the tool can be measured (via force/pressure sensor) and controlled via close-loop feedback control, these two terms as they are used herein are not limited to such a strict interpretation. Rather, “force/pressure” used herein are meant to convey that a predetermined urging force of a given magnitude is imparted on the tool and the predetermined force has empirically been determined to produce the desired amount of “work” against the media in a given situation.

What is claimed is:

1. Method for cutting materials with a crafting apparatus, comprising:
(a) storing settings for various cutting materials to be cut,
(b) performing an algorithm to determine pressure changes over a series of cuts,
(c) cutting a cutting material with said pressure changes over multiple cuts.

2. Method for cutting thick materials with a crafting apparatus, comprising:
(a) storing settings for various cutting materials to be cut in a cutting apparatus processor,
(b) performing an algorithm within a cutting apparatus processor to determine pressure changes over a series of cuts,
(c) cutting a cutting material with said crafting apparatus with said pressure changes over multiple cuts.

3. Method for cutting thick materials with a crafting apparatus, comprising:
(a) storing settings for various cutting materials to be cut in computer software,
(b) performing an algorithm within computer software to determine pressure changes over a series of cuts,
(c) delivering said pressure changes to said crafting apparatus
(d) cutting a cutting material with said crafting apparatus with said pressure changes over multiple cuts.

4. A method of using a crafting device to control a working tool as it traverses against a media, comprising:
(a) defining and storing in electronic memory a traversal path to be traversed by said working tool,
(b) defining and storing in electronic memory the number of re-trace occurrences wherein the crafting device will direct the working tool to re-trace the traversal path,
(c) using the crafting device to electronically manipulate the working tool to contact the media with a first urging force and to direct the working tool along the traversal path, then
(d) using the crafting device to manipulate the working tool against the media with a second urging force and to trace the traversal path a second occurrence.

5. The method of claim 4, wherein the number of re-trace occurrences is user selectable.

6. The method of claim 4, wherein the number of the re-trace occurrences is determined in part after the user is allowed to examine a test cut prepared by the crafting device using the media.

7. The method of claim 4, further including the step of:
(a) using the crafting device to electronically manipulate the working tool against the media with a third urging force and to trace the traversal path a third time.

8. The method of claim 7, wherein the first, second, and third urging forces are all of different magnitude and the difference between the first and second urging force and the second and third urging force is equal.

9. The method of claim 8, wherein the first, second, and third urging forces are determined using mathematic functions.

10. The method of claim 4, wherein the first urging force is greater than the second urging force.

11. The method of claim 4, wherein the first urging force is less than the second urging force.

12. The method of claim 4, wherein the working tool movement is paused during its traversal of the media, thereby allowing the user to change working tools.

13. The method of using a crafting device to control a working tool as it traverses against a media comprising:
defining and storing in electronic memory a traversal path to be traversed by said working tool,
defining at least a first and a second segment to said traversal path,
assigning a first urging force magnitude value to said first segment of said traversal path and a second urging force magnitude value to said second segment of said traversal path,
using the crafting device to electronically manipulate the working tool to contact the media and to urge said tool against said media according to said first urging force value, then
directing said working tool along the first segment of the traversal path, then
using the crafting device to electronically manipulate the working tool to contact the media and to urge said tool against the media according to said second urging force value, then
directing said working tool along the second segment of the traversal path.

14. The method of claim 13, wherein the magnitude of the first urging force is less than the magnitude of the second urging force.

15. The method of claim 13, wherein the magnitude of the first urging force is greater than the magnitude of the second urging force.

16. The method of claim 13, wherein the at least first and second urging force magnitude values include at least a third urging force magnitude value and the magnitude of the at least first, second, and third urging force values is user selectable.

17. The method of claim 13, wherein the traversal path is a portion of a letter, numeral, or glyph.

18. The method of claim 17, wherein the traversal path is a portion of a calligraphy style character.
